(19) United States
(12) Patent Application Publication
(10) Pub. No.: US 2011/0168478 A1
(43) Pub. Date: Jul. 14, 2011

(54) INTERFACE APPARATUS FOR MANIPULATING WHEELCHAIR AND WHEELCHAIR USING THE SAME

(75) Inventors: CHUNG-HSIEN KUO, Taipei (TW); Kuo-Wei Chiu, Taipei (TW); Yang-Hua Lin, Taipei (TW)

(73) Assignee: National Taiwan University of Science and Technology, Taipei (TW)

(21) Appl. No.: 12/850,196

(22) Filed: Aug. 4, 2010

(30) Foreign Application Priority Data
Jan. 13, 2010 (TW) 099100763

(51) Int. Cl. B60K 26/00; B60Q 1/00

(52) U.S. Cl. 180/315; 340/425.5

(57) ABSTRACT

The present invention provides an interface apparatus for manipulating a wheelchair which is capable of controlling the translation/rotation of the wheelchair by means of a pair of sliding mechanisms. In addition, there is at least one physiological sensor being disposed on each sliding mechanism for detecting physiological status of a user sitting on the wheelchair so as to monitor the bio-status of the user via a closed bio-potential circuit. The pair of sliding mechanisms are disposed respectively on their corresponding arm rest of the wheelchair so that the user can manipulating the wheelchair by two hands grasping the corresponding sliding mechanism while the physiological sensor can detect the physiological status of the user. With the aforesaid apparatus and wheelchair, it not only can provide a directly operating way with human-factor concerns but can also monitor the physiological status of the user so as to improve the safety in manipulation.

### FIELD OF THE INVENTION

The present invention relates to a manipulation interface apparatus, and more particularly, to an interface apparatus for manipulating a wheelchair capable of controlling the translation or rotation of the wheelchair while monitoring the bio-status of a user sitting on the wheelchair via the detection of a closed bio-potential circuit.

### BACKGROUND OF THE INVENTION

A wheelchair is a wheeled mobility device that is propelled either manually (by turning the wheels by the hand) or via various automated systems and is used by people for whom walking is difficult or impossible due to illness (physiological or physical), injury, or disability. Wheelchairs are important aids for mobility.

Please refer to FIG. 1, which shows a conventional manual wheelchair. In FIG. 1, a basic standard manual wheelchair 1 is shown, which incorporates a seat 10, two arm rests 11 12, two small front casters, and two large wheels 13, two foot rests and two handles, one on each side. Manual wheelchairs are those that require human power to move them and thus they can be propelled to move either by the occupant or by an attendant using the handles. For the self-propelled wheelchair, the user moves the wheelchair 1 by pushing on the handrims, which are made of circular tubing attached to the outside of the large wheels 13. When both handrims are grasped together, the wheelchair 1 may be propelled forward or backward in a straight line; and when either handrim is moved independently, the wheelchair 1 will turn left or right in response to the handrim used. The attendant-propelled chairs, being designed to be propelled by an attendant using the handles, are most often being used when the occupant may be too weak or handicapped that he/she is not capable of operating the wheelchairs by themselves. Nevertheless, to operate the manual wheelchair for controlling the wheelchair to climb and descend curbs and move over small obstacles may be physically challenging for the occupants, especially when the occupant can not afford to hire an attendant.

Please refer to FIG. 2, which shows a conventional motorized wheelchair. In FIG. 2, the motorized wheelchair 1 is a wheelchair that is moved via the means of an electric motor and navigational controls rather than manual power. The user typically controls speed and direction by operating a joystick 14 on one art rest 12 at a side of its seat 10. Although the motorized wheelchair are useful for those who are too weak to or otherwise unable to move around themselves in a manual wheelchair, but the operation of such motorized wheelchairs through the use of joystick 14 can still problematic for elders or users lacking coordination or the use of the hands or fingers. Moreover, most conventional motorized wheelchairs are designed as a signal-hand operating device that a user can control the movement of a motorized wheelchair by on hand grasping on the joystick, which is significantly different from transportation means, such as motorcycles, bicycles and cars. Therefore, the design of such motorized wheelchair as a signal-hand operating device can create problems with respect to ergonomic, handling and stability. In addition, it is difficult to form a stable closed bio-potential circuit in such conventional motorized wheelchair due to its signal-hand operation design so that it is hard to detect physiological status of a user sitting on the wheelchair so as to monitor the bio-status of the user.

Therefore, it is in need of an interface apparatus for manipulating a wheelchair for overcoming the aforesaid problems.

### SUMMARY OF THE INVENTION

In view of the disadvantages of prior art, the object of the present invention is to provide an interface apparatus for manipulating a wheelchair and the wheelchair using the same, capable of controlling the translation/rotation of the wheelchair by means of a pair of sliding mechanisms disposed respectively on their corresponding arm rest of the wheelchair so that the user can manipulating the wheelchair by two hands grasping the corresponding sliding mechanism, and thereby, not only enabling the user to manipulate the wheelchair in an intuitive manner, but also improving the safety in manipulating the wheelchair.

It is another object of the invention to provide an interface apparatus for manipulating a wheelchair and the wheelchair using the same, capable of forming a closed bio-potential circuit by the use of at least one physiological sensor mounted on the wheelchair for detecting physiological status of a user sitting on the wheelchair, and thereby, monitoring the bio-status of the same to be used as secondary safety control mechanism for the wheelchair. In addition, the wheelchair is further configured with a storage media and a wireless transmission unit, by that the bio status detected can be stored in the storage media and provided to physician as basis of diagnosis, and the wireless transmission unit can be activated as soon as there is abnormality in the bio status for transmitting an alarm signal to a central control or medical center.

To achieve the above objects, the present invention provides an interface apparatus for manipulating a wheelchair, comprising: a pair of two-way sliding mechanisms, each being configured with a base and a sliding sleeve in a manner that the sliding sleeve, having at least one physiological sensor disposed therein, is mounted on the base while enabling the same to slide in a first direction and a second direction, capable of using a closed bio-potential circuit formed by the use of the physiological sensors of the two two-way sliding mechanisms to detect a physiological status and thus generating a physiological status signal accordingly; a pair of manipulation sensors, mounted respectively on the pair of two-way sliding mechanisms for detecting the sliding of their corresponding sliding sleeve and thus generating a sliding status signal accordingly; and a control unit, electrically connected to the pair of manipulation sensors and each physiological sensor, for processing the sliding status signal and the physiological status signal so as to correspondingly generate a power control signal and a bio signal accordingly.

To achieve the above objects, the present invention provides a wheelchair, comprising: a seat, having two arm rests respectively disposed at the two sides thereof, being coupled to a wheel module as the wheel module is further connected to a power output module in a manner that the wheel module is powered by the power output module for driving the seat to move therewith; a pair of two-way sliding mechanisms, disposed respectively on the two arm rests as each being configured with a base and a sliding sleeve in a manner that the sliding sleeve, having at least one physiological sensor disposed therein, is mounted on the base while enabling the same to slide in a first direction and a second direction, capable of using a closed bio-potential circuit formed by the use of the physiological sensors of the two two-way sliding mechanisms to detect a physiological status and thus generating a physiological status signal accordingly; a pair of manipulation sensors, mounted respectively on the pair of two-way sliding mechanisms for detecting the sliding of their corresponding sliding sleeve and thus generating a sliding status signal accordingly; and a control unit, electrically connected to each physiological sensor, the pair of manipulation sensors and the power output module, for receiving and processing the sliding status signal and the physiological status signal so as to correspondingly generate a power control signal to the power output module and a bio signal accordingly.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 and FIG. 2 show respectively a conventional manual wheelchair and a motorized wheelchair.

FIG. 3A and FIG. 3B are schematic views of an interface apparatus for manipulating a wheelchair according to an embodiment of the invention.

FIG. 4 is a block diagram showing how a physiological status signal is being processed into a bio signal in a signal processing unit of the invention.

FIG. 5 is a block diagram of an interface apparatus for manipulating a wheelchair according to an embodiment of the invention.

FIG. 6 is a three dimensional view of a wheelchair of the present invention.

FIG. 7 is a schematic diagram showing the relationship between the wheel module and power output module of the invention.

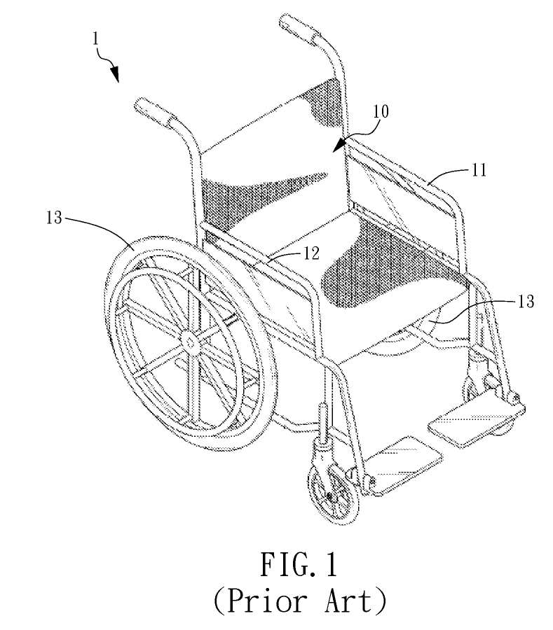

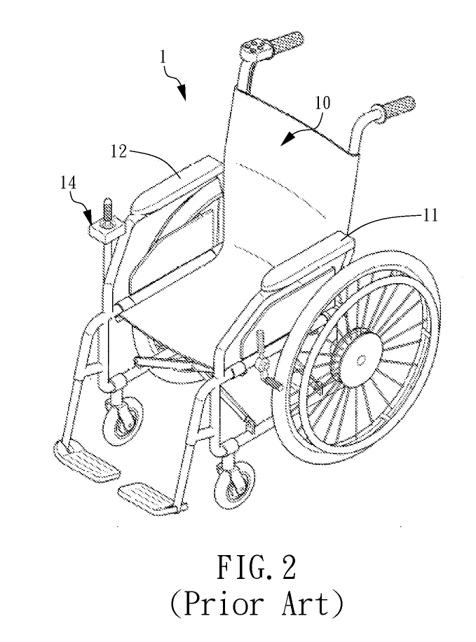

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

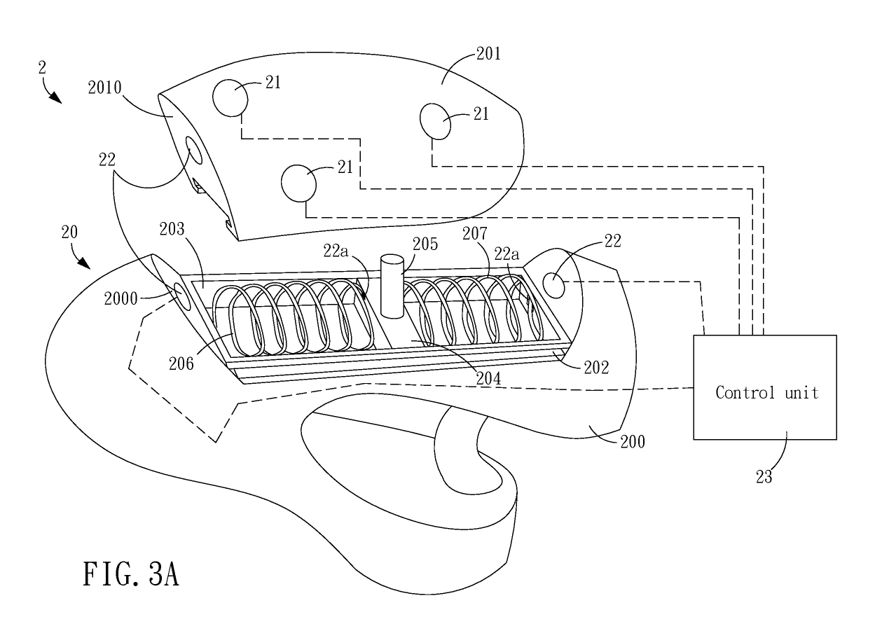

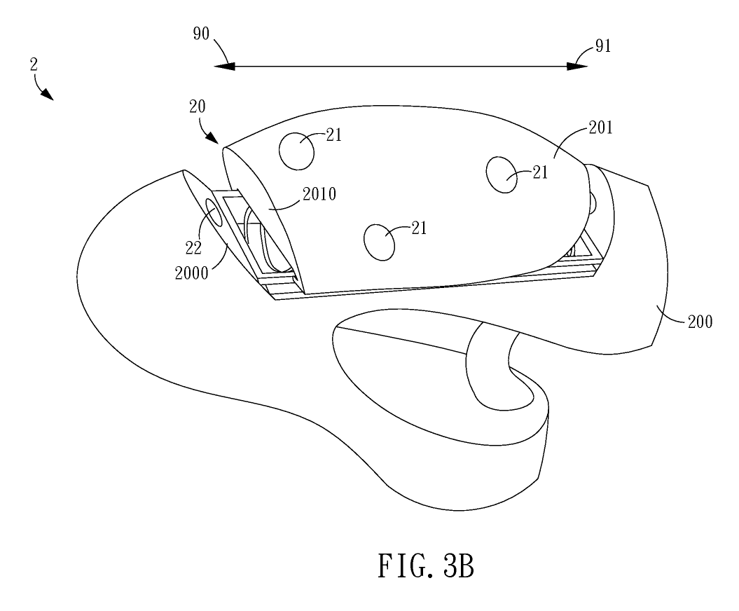

Please refer to FIG. 3A and FIG. 3B, which are schematic views of an interface apparatus for manipulating a wheelchair according to an embodiment of the invention. As shown in FIG. 3A and FIG. 3B, an interface apparatus 2 is disclosed, which comprises: a two-way sliding mechanism 20, at least one physiological sensor 21, a manipulation sensor 22 and a control unit 23. The two-way sliding mechanism 20 is configured with a base 200 and a sliding sleeve 201 in a manner that the sliding sleeve 201 is mounted on a guide rail 202 fitted on the base 200 while enabling the same to slide linearly in a first direction 90 and a second direction 91. In this embodiment, the base 200 is formed with a accommodation space 203 that is provided for a sliding block 204 to be received therein while enabling the sliding block 204 to connected with the sliding sleeve 201 by the use of an extruding column 205 formed on the sliding block 204 as is provided to be inset into the sliding sleeve 201 so as to connect the sliding block 204 with the sliding sleeve 201. In addition, there are two elastic members 206, 207 being arranged inside the accommodation space 203 respectively at the two sides of the sliding block 204. In this embodiment, each elastic member 206, 207 can be a spring. When the sliding sleeve 201 is pushed to move by a user in the first direction 90, the elastic member 207 will be pressed by the sliding block 204 while the elastic member 206 is being stretched, and thus, as soon as the sliding sleeve 201 is released, the resilience of the two elastic members 206, 207 will force the sliding block 201 to move back to its original position. As the operations of the elastic members 206, 207 when the sliding sleeve 201 is moved in the second direction 91 will be similar to the foregoing description, it will not be described further herein.

As shown in FIG. 3A, there is at least one physiological sensor 21 being arranged on the sliding sleeve 201 that is provided for detecting a physiological status and thus generating a physiological status signal accordingly. It is noted that the amount of the physiological sensor 21 is not limited by the present embodiment, and this can be determined according to actual requirement that theoretically one such physiological sensor 21 is sufficient for the task. However, in order to provide a more precise detection, there can be a plurality of such physiological sensor 21 used in the interface apparatus 2 of the invention, as those shown in FIG. 3A and FIG. 3B. It is noted that by arranging multiple physiological sensor 21 in the interface apparatus 2, the detection stability of the physiological status signal can be enhanced. As the sliding sleeve 201 might be grasped by different users at different positions thereof, or even by the same user at different positions under different operation situations, detection stability of the physiological status signal can be enhanced if there are a plurality of such physiological sensor 21 being arranged on the sliding sleeve 201 so that no matter it is being grasped by a user at any position, the detection of the physiological status signal can be ensured. Nevertheless, the plural physiological sensor 21 will correspondingly generate a plurality of physiological status signals, so that it is required for the control unit 23 to perform a proximity test upon those physiological status signals for deleting some of the physiological status signal that are not accurate so as to enhance the precision of the detection. In this embodiment, the physiological sensor 2 is the electrocardiograph (ECG) sensor, but is not limited thereby, which can be a temperature sensor, a blood sugar sensor, or the like.

The manipulation sensor 22, being disposed on the two-way sliding mechanism 20, is used for detecting the sliding status of the sliding sleeve 201 with respect to its position and thus generating a sliding status signal accordingly. There can be a variety of sensors capable of be adopted as the manipulation sensor 22, such as optic sensors, ultrasonic sensors or force sensors. In this embodiment, the manipulation sensor 22 is an optic sensor, such as an infrared sensor or a laser detector, which is designed for detecting the sliding status of the sliding sleeve 201 with respect to its position and thus generating a sliding status signal accordingly. When the sliding sleeve 201 is moving in the first direction 90 or the second direction 91, the relative distance between an end 2010 of the sliding sleeve 201 and its corresponding sensing end 2000 of the base 20 will be varying accordingly. Therefore, the translation of the sliding sleeve 201 can be detected by arranging an optic sensor on the two ends 2000 and 2010. Nevertheless, when a force sensor 22a is used as the manipulation sensor 22, it is being arranged on a surface of the base 200 that is provided to abut against either with the elastic member 206, or another elastic member 207, so that the force subjected by either the elastic member 206 or the elastic member 207 can be detected no matter it is being pressed or stretched, and thus a sliding status signal with respect to the strength of force being exerted on the sliding sleeve can be generated. Operationally, the sliding status signal is send to the control unit 23, where a calculation for obtaining the deformation of the elastic members 206, 207 is performed according to the equation: F=k×S, whereas F represents a force; k is the elastic coefficient of corresponding elastic member; and S represents the deformation. Thereby, the translation of the sliding sleeve 201 can be obtained. In addition, the control unit 23, being electrically connected to the manipulation sensor 22 and each physiological sensor 21, is used for processing the sliding status signal and the physiological status signal so as to correspondingly generate a power control signal and a bio signal accordingly.

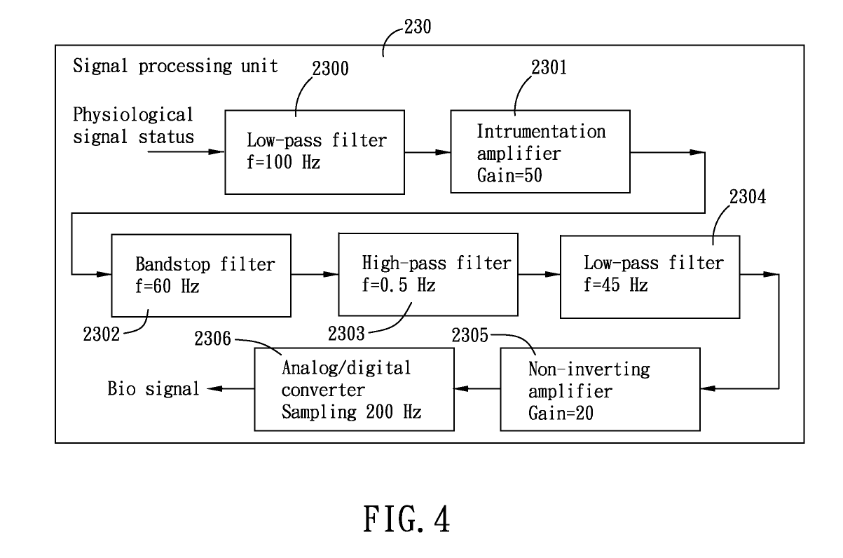

With respect to the receiving of the physiological status signal for correspondingly generating a bio signal accordingly that is performed by the control unit 23, it is being illustrated hereinafter by ECG as an ECG sensor is being used as the physiological sensor 21 in the present embodiment. It is known that electrical impulses in the heart originate in the sinoatrial node and travel through the intimate conducting system to the heart muscle. The impulses stimulate the myocardial muscle fibres to contract and thus induce systole. The electrical waves can be measured at electrodes placed at specific points on the skin. Thus, Electrocardiography (ECG) is a transthoracic interpretation of the electrical activity of the heart over time captured and externally recorded by skin electrodes. Please refer to FIG. 4, which is a block diagram showing how a physiological status signal is being processed into a bio signal in a signal processing unit of the invention. In this embodiment, the control unit 23 further comprises a signal processing unit 230 for processing the physiological status signals. Generally, the frequencies of the physiological status signals in ECG are ranged under 150 Hz with amplitudes about 1 mv. Therefore, it is required a circuit with amplification and filtration abilities for processing the detected ECG signals as the detected ECG signals can be very weak. As shown in FIG. 4, the physiological status signal is first being processed by a low-pass filter 2300, and then it is being processed by a instrumental amplifier 2301 and an non-inverting amplifier 2305 for amplifying the signal by 1000 times. After that, the amplified signal is filtered by a bandstop filter 2302, a high-pass filter 2303 and a low-pass filter 2304, and then is fed to an analog/digital converter 2306 where it is converted so as to form an ECG bio signal.

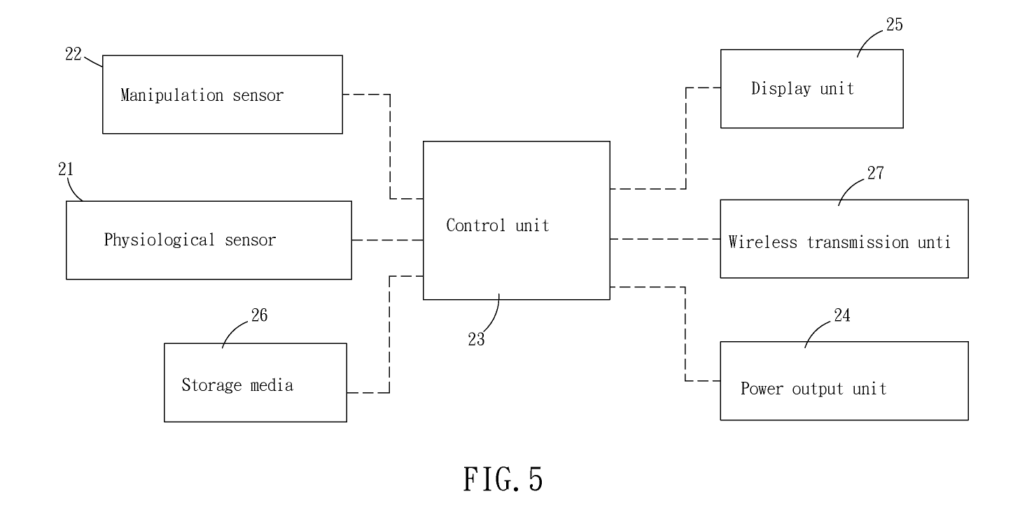

Please refer to FIG. 5, which is a block diagram of an interface apparatus for manipulating a wheelchair according to an embodiment of the invention. As shown in FIG. 5, the power control signal generated from the control unit 23 is transmitted to a power output unit 24, whereas the power output unit 24 can be an assembly of a gearbox and a motor. As the sliding status signal containing information relating to the translation and sliding direction of the sliding sleeve on the base, the control unit 23 is able to control the direction of rotation as well as the rotation speed of the motor in the power output unit 24 according to the sliding direction and amount of translation contained in the sliding status signal so as to control the progressing direction and speed of the wheelchair. In addition, the bio signal can be transmitted to a display unit 25, where it is displayed for enabling an user or an attendant to aware of the user's physical condition. It is noted that the display unit can be a flat panel displayer such as liquid crystal display or light-emitting diode display, etc.

Moreover, the control unit 23 is further coupled to a storage media 26, which is provided for receiving and storing the bio signal generated from the control unit 23. In this embodiment, the storage media 26 can be an universal serial bus (USB) flash memory, such as secure digital (SD) card, compact flash (CF) card, etc., but is not limited thereby. For instance, the storage media 26 can be a hard disk in another embodiment. In addition, the control unit 23 is further connected to a wireless transmission unit 27, which can be a blue tooth transmission interface, a radio frequency identification (RFID) interface, a wireless network communication interface, an infrared transmission interface, or the combinations thereof. By the use of the wireless transmission unit 27, the bio signal can be send to a remote central control or to a care center where it is being monitored. The control unit 23 is further designed with an alarm evaluation mechanism, by that an alarm signal can be issued by the control unit 23 which is then being transmitted out by the wireless transmission unit 27 to the central control or the care center as soon as the evaluation performed in the control unit 23 according to the bio signal suggests that a safety threshold had been exceeded. Moreover, the alarm signal can be transmitted directly to a doctor, a nurse or a paramedic personnel so that the user sitting on the wheelchair can have medical attention in real time.

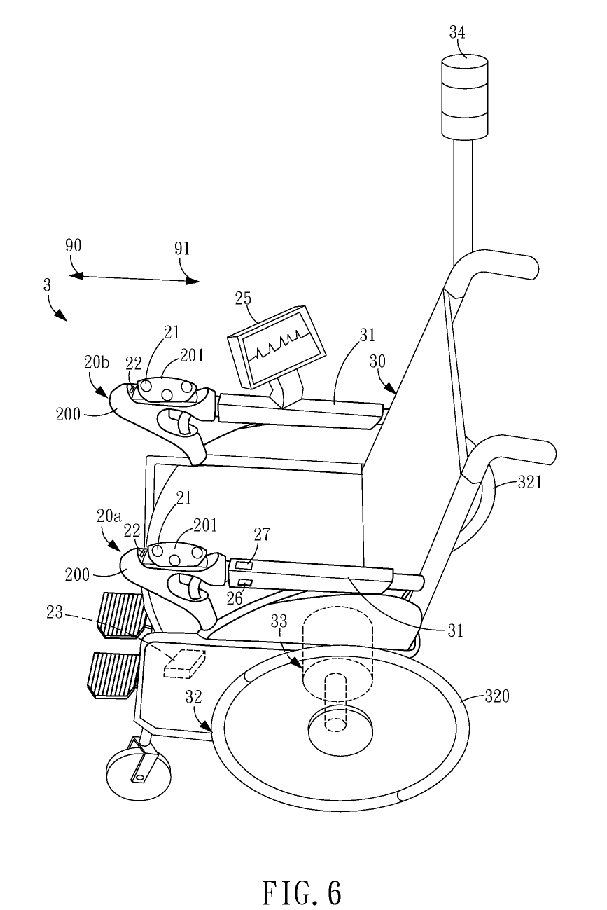

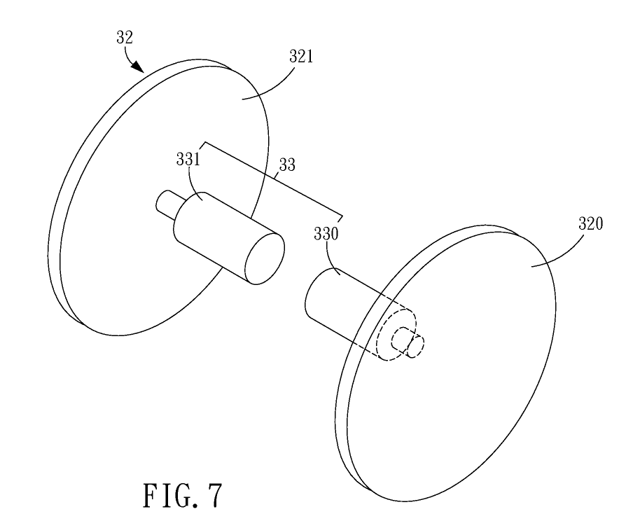

Please refer to FIG. 6, which is a three dimensional view of a wheelchair of the present invention. As shown in FIG. 6, a wheelchair 3 comprises: a seat 30, which has two arm rests 31 respectively disposed at the two sides thereof, and is being coupled to a wheel module 32 as the wheel module is further connected to a power output module 33 in a manner that the wheel module is powered by the power output module 33 for driving the seat 30 to move therewith. In the embodiment shown in FIG. 7, the wheel module 32 is configured with two driving wheels 320, 321, whereas the power output module 33 is configured with two power output units 330, 331 that are coupled respectively to their corresponding driving wheels 320, 321. It is noted that each power output units 330, 331 can be an assembly of a gearbox and a motor.

In FIG. 6, there are two two-way sliding mechanisms 20a, 20b being arranged respectively on the two arm rests 31. In this embodiment, the two two-way sliding mechanisms 20a, 20b are arranged at the front ends of their corresponding arm rest 31, but are not limited thereby. For instance, each of the two sliding mechanisms 20a, 20b can be arranged at the middle portion of its corresponding arm rest 31, which is dependent upon actual requirement. Each of the two sliding mechanisms 20a, 20b is structured similar to the embodiment shown in FIG. 3A, which is also configured with a base 200 and a sliding sleeve 201 in a manner that the sliding sleeve 201 is mounted on the base 200 while enabling the sliding sleeve 201 to slide in a first direction and a second direction. As the base 200 is constructed the same as that shown in FIG. 3A and FIG. 3B, it is not described further herein. Similarly, Each sliding mechanisms 20a, 20b is configured with at least one physiological sensor 21, that is provided for detecting a physiological status of a user sitting on the wheelchair 3 and thus generating a physiological status signal accordingly. When the user sitting on the wheelchair 3 grasp the two two-way sliding mechanisms 20a, 20b respectively by the two hands thereof, the contacting of the physiological sensors and the hands will form a closed bio-potential circuit which can be used for detecting a physiological status of a user sitting on the wheelchair 3 and thus generating a physiological status signal accordingly. Moreover, there are two manipulation sensors 22 being arranged respectively on the two sliding base 200, which are provided for detecting the sliding status of their corresponding sliding sleeve 201 and thus generating a sliding status signal accordingly. It is noted that each manipulation sensor 22 can be an optic sensor, a ultrasonic sensor, or a force sensor, etc.

The wheelchair 3 further comprises a control unit 23, which is electrically connected to each physiological sensor 21, the pair of manipulation sensors 22 and the power output module 33, and is provided for receiving and processing the sliding status signal and the physiological status signal so as to correspondingly generate a power control signal to the power output module 33 and a bio signal accordingly. In this embodiment, the two two-way sliding mechanisms 20a, 20b can be operated in five different manners, which are as flowing: both are enabled to slide simultaneously in a first direction 90; both are enabled to slide simultaneously in a second direction 91; the two-way sliding mechanism 20a is enabled to slide in the first direction 90 while another two-way sliding mechanism 20b is enabled to slide in the second direction 91; the two-way sliding mechanism 20a is enabled to slide in the second direction 91 while another two-way sliding mechanism 20b is enabled to slide in the first direction 90; both are enabled to be stationed without moving.

In the first condition when both of the two two-way sliding mechanisms 20a, 20 are enabled to slide simultaneously in the first direction 90, the two sleeve sleeves 201 are grasped respectively by the two hands of a user sitting on the wheelchair 3 which are forced to sliding in the first direction 90 and thus cause the control unit 23 to generate a power control signal to the power output module 33 for directing the power output units 330, 331 to output simultaneously rotation powers respectively to their corresponding driving wheels 320, 321 so as to enable the two to rotate counterclockwisely. Thereby, the wheelchair 3 is driven to move in the first direction 90, that is, to move forward as shown in FIG. 6 and FIG. 7. On the other hand, when both of the two two-way sliding mechanisms 20a, 20 are enabled to slide simultaneously in the second direction 91, the two sleeve sleeves 201 are grasped respectively by the two hands of the user sitting on the wheelchair 3 which are forced to sliding in the second direction 91 and thus cause the control unit 23 to generate a power control signal to the power output module 33 for directing the power output units 330, 331 to output simultaneously rotation powers respectively to their corresponding driving wheels 320, 321 so as to enable the two to rotate clockwisely. Thereby, the wheelchair 3 is driven to move in the second direction 91, that is, to move backward. It is noted that the power being outputted from the two power output units 330, 331 that are controlled by the control unit 23 are determined according to the translations of the sliding sleeves 201 of the two two-way sliding mechanisms 20a, 20b, and thus the moving speed of the wheelchair 3 can be determined accordingly. Moreover, the third and the four conditions are designed for controlling the wheelchair 3 to revolve, that is, when the two-way sliding mechanism 20a is enabled to slide in the first direction 90 while another two-way sliding mechanism 20b is enabled to slide in the second direction 91, or when the two-way sliding mechanism 20a is enabled to slide in the second direction 91 while another two-way sliding mechanism 20b is enabled to slide in the first direction 90, the control unit 23 can control the power output units 330, 331 for driving their corresponding driving wheels 320, 321 to rotated in opposite directions so as to enable the wheelchair to revolve clockwisely or counterclockwisely.

Nevertheless, the aforesaid five operation conditions respect to the two two-way sliding mechanisms 20a, 20b are only for illustration that the operation of the two-way sliding mechanisms 20a, 20b are not limited thereby. For instance, the user sitting on the wheelchair 3 can slide only one sliding sleeve 201 while enabling another sliding sleeve 201 to remain stationary, by that only one power output unit, i.e. either the power output unit 330, or another power output unit 331, but not both, correspond to the sliding of the enabled sliding sleeve 201 will be activated for driving its corresponding driving wheel to rotate for causing the wheelchair 3 to revolve. Furthermore, the user can enabled the two sliding sleeves 201 to move differently, so that the powers outputted from the two power output units 330, 331 will be different correspondingly for causing the wheelchair 3 to revolve, In the aforesaid conditions, the control unit 23 can be designed to process signals from the two two-way sliding mechanisms 20a, 20b in two different manners. One of which is to process signals from the two two-way sliding mechanisms 20a, 20b respectively or one after another so as to issue two corresponding power control signals. Another manner is that: the signals from the two two-way sliding mechanisms 20a, 20b are combined and processed simultaneously so as to obtained a moving vector to be used as a base for issuing corresponding power control signals to the power output units.

With respect to the receiving of the physiological status signal for correspondingly generating a bio signal accordingly, the wheelchair 3 is further being configured with a display unit 25 for displaying the bio signal. Moreover, the wheelchair 3 is further being configured with a storage media 26 for registering the bio signal. It is noted that, in this embodiment, the storage media 26 is a CF card, which is similar to that described hereinbefore, and thus will not be described further herein. By the disposition of the storage media 26 in the wheelchair 3, the physical conditions of a use sitting of the wheelchair 3 can be obtained by physicians simply by removing the storage media 26 from the wheelchair 3 and inserting the same into a computer. Moreover, the control unit 23 is further connected to a wireless transmission unit 27, by that the bio signal can be send to a remote central control or to a care center where it is being monitored. The control unit 23 is further designed with an alarm evaluation mechanism, by that an alarm signal can be issued by the control unit 23 which is then being transmitted out by the wireless transmission unit 27 to the central control or the care center as soon as the evaluation performed in the control unit 23 according to the bio signal suggests that a safety threshold had been exceeded. Moreover, the alarm signal can be transmitted directly to a doctor, a nurse or a paramedic personnel so that the user sitting on the wheelchair can have medical attention in real time; or even can be send to an alerting unit 34 arranged on the wheelchair 3 for enabling the same to generate an alarm in a form of light, sound or the combination thereof.

Moreover, the control unit can be designed to make an evaluation to determine whether or not to issue the power control signal according to the physiological status signal. That is, when there is any abnormality in the physiological status signal, the control unit can make a decision that it will not issue the power control signal even at a condition that when the sliding sleeves are being pushed to move by a user sitting on the wheelchair 3. Thereby, as the abnormality in the physiological status signal can represent that there can be certain physical problems to the user, the control unit will stop the issuing of power output signal in response to the movement of the sliding sleeve for safety precaution.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. An interface apparatus for manipulating a wheelchair, comprising:
a pair of two-way sliding mechanisms, each being configured with a base and a sliding sleeve in a manner that the sliding sleeve, having at least one physiological sensor disposed therein, is mounted on the base while enabling the same to slide in a first direction and a second direction, capable of using a closed bio-potential circuit formed by the use of the physiological sensors of the two two-way sliding mechanisms to detect a physiological status and thus generating a physiological status signal accordingly;
a pair of manipulation sensors, mounted respectively on the pair of two-way sliding mechanisms for detecting the sliding status of their corresponding sliding sleeve and thus generating a sliding status signal accordingly; and
a control unit, electrically connected to the pair of manipulation sensors and each physiological sensor, for processing the sliding status signal and the physiological status signal so as to correspondingly generate a power control signal and a bio signal accordingly.

2. The interface apparatus of claim 1, wherein each base is further comprised of:
an accommodation space;
a sliding block, slidably received inside the accommodation space while enabling the same to coupled with the corresponding sliding sleeve in a manner that the sliding is capable of being driven to perform a translation movement by the sliding of the sliding sleeve; and
a pair of elastic members, being disposed inside the accommodation space while being arranged respectively at the two side of the sliding block.

3. The interface apparatus of claim 2, wherein each manipulation sensor is a device selected from the group consisting of: a force sensor being designed for detecting forces exerting on the pair of the elastic members so as to generate the sliding status signal accordingly; an ultrasonic sensor being designed for detecting the position of its corresponding sliding sleeve so as to generate the sliding status signal accordingly; and an optic sensor being designed for detecting the position of its corresponding sliding sleeve so as to generate the sliding status signal accordingly.

4. The interface apparatus of claim 1, wherein the control unit is further coupled to a power output unit as the power output unit is designed for output a power according to the power control signal received thereby.

5. The interface apparatus of claim 1, wherein the control unit is further coupled to a storage media, provided for receiving and storing the bio signal.

6. The interface apparatus of claim 1, wherein the control unit is further coupled to a wireless transmission unit in a manner that an alarm signal issued by the control unit is transmitted out by the wireless transmission unit as soon as an safety evaluation performed in the control unit according to the bio signal suggests that a safety threshold had been exceeded.

7. A wheelchair, comprising:
a seat, having two arm rests respectively disposed at the two sides thereof, being coupled to a wheel module as the wheel module is further connected to a power output module in a manner that the wheel module is powered by the power output module for driving the seat to move therewith;
a pair of two-way sliding mechanisms, disposed respectively on the two arm rests as each being configured with a base and a sliding sleeve in a manner that the sliding sleeve, having at least one physiological sensor disposed therein, is mounted on the base while enabling the same to slide in a first direction and a second direction, capable of using a closed bio-potential circuit formed by the use of the physiological sensors of the two two-way sliding mechanisms to detect a physiological status and thus generating a physiological status signal accordingly;
a pair of manipulation sensors, mounted respectively on the pair of two-way sliding mechanisms for detecting the sliding status of their corresponding sliding sleeve and thus generating a sliding status signal accordingly; and
a control unit, electrically connected to each physiological sensor, the pair of manipulation sensors and the power output module, for receiving and processing the sliding status signal and the physiological status signal so as to correspondingly generate a power control signal to the power output module and a bio signal accordingly.

8. The wheelchair of claim 7, wherein each base is further comprised of:
an accommodation space;
a sliding block, slidably received inside the accommodation space while enabling the same to coupled with the corresponding sliding sleeve in a manner that the sliding is capable of being driven to perform a translation movement by the sliding of the sliding sleeve; and
a pair of elastic members, being disposed inside the accommodation space while being arranged respectively at the two side of the sliding block.

9. The wheelchair of claim 8, wherein each manipulation sensor is a device selected from the group consisting of: a force sensor being designed for detecting forces exerting on the pair of the elastic members so as to generate the sliding status signal accordingly; an ultrasonic sensor being designed for detecting the position of its corresponding sliding sleeve so as to generate the sliding status signal accordingly; and an optic sensor being designed for detecting the position of its corresponding sliding sleeve so as to generate the sliding status signal accordingly.

10. The wheelchair of claim 7, wherein the control unit is further coupled to a storage media, provided for receiving and storing the bio signal.

11. The wheelchair of claim 7, wherein the control unit is further coupled to a wireless transmission unit in a manner that an alarm signal issued by the control unit is transmitted out by the wireless transmission unit as soon as an safety evaluation performed in the control unit according to the bio signal suggests that a safety threshold had been exceeded.

12. The wheelchair of claim 7, wherein further comprising:
an alerting unit, electrically connected to the control unit, capable of issuing an alarm according to the alarm signal.

13. The wheelchair of claim 7, further comprising:
a display unit, electrically connected to the control unit, for displaying the bio signal.
